(19) United States
(12) Patent Application Publication
(10) Pub. No.: US 2024/0048456 A1
(43) Pub. Date: Feb. 8, 2024

(54) METHODS AND APPARATUSES FOR UPDATING TRAFFIC PREDICTION SYSTEM

(71) Applicant: Alipay (Hangzhou) Information Technology Co., Ltd., Hangzhou (CN)

(72) Inventors: Ting Li, Hangzhou (CN); Xiangyang Liu, Hangzhou (CN); Jianguo Li, Hangzhou (CN)

(73) Assignee: Alipay (Hangzhou) Information Technology Co., Ltd., Hangzhou (CN)

(21) Appl. No.: 18/364,247

(22) Filed: Aug. 2, 2023

(30) Foreign Application Priority Data
Aug. 2, 2022 (CN) 202210924959.9

(51) Int. Cl. H04L 41/147; G06N 3/049; G06N 3/048; G06F 17/16

(52) U.S. Cl. CPC H04L 41/147; G06N 3/049; G06N 3/048; G06F 17/16

(57) ABSTRACT

First graph structure data indicating connectivity relationships mined for N object nodes is generated based on node representation parameters. The first graph structure data and node traffic data including T traffic values of each object node at T time points is processed to obtain N first embedded representations of the N object nodes. Second graph structure data indicating original connectivity relationships pre-generated for N object nodes and the node traffic data are processed to obtain N second embedded representations of the N object nodes. Fusion processing is performed on the N first embedded representations and the N second embedded representations to obtain a fused representation matrix, which is processed with the T traffic values. A predicted traffic value of each object node after the T time points is determined. Parameters are updated in a traffic prediction system based on the predicted traffic value and a corresponding actual traffic value.

### CROSS-REFERENCE TO RELATED APPLICATIONS

This application claims priority to Chinese Patent Application No. 202210924959.9, filed on Aug. 2, 2022, which is hereby incorporated by reference in its entirety.

### TECHNICAL FIELD

One or more embodiments of this specification relate to the technical field of machine learning, and in particular, to methods and apparatuses for updating a traffic prediction system, and methods and apparatuses for updating an index prediction system.

### BACKGROUND

Constructing machine learning models for multivariate time series prediction has become a major research hotspot at present, in which multiple variables involved are usually variables with some correlations in a certain service scenario, and time series prediction involves using historical sequence data of each of the multiple variable to predict data at a future time point. For example, in a cloud service scenario, multiple business variables are multiple traffic variables corresponding to multiple pages in different applications. In this case, it can be considered that there is an association between pages corresponding to the same application, so that data traffic of each page at a certain future time point can be predicted based on this association and a historical traffic sequence collected for each page, and thus a cloud service platform can make decisions on scheduling of related service resources in advance based on a prediction result, so as to better serve users.

However, it is difficult to use current multivariable time series prediction methods to meet increasing actual application demands. Therefore, there is need for a solution that can effectively improve accuracy of multivariate time series prediction results, so as to improve user experience.

### SUMMARY

Some embodiments of this specification describe methods and apparatuses for updating a traffic prediction system, and methods and apparatuses for updating an index prediction system. Explicit graph structure data determined based on prior knowledge are fused with mined graph structure data, so that a fusion result is used to predict indexes such as traffic, thereby effectively improving accuracy of prediction of indexes such as traffic.

According to a first aspect, a method for updating a traffic prediction system is provided, where the traffic prediction system includes a graph generation module, a temporal sequence network, and two graph neural networks, and the method includes following: First graph structure data are generated based on node representation parameters in the graph generation module that are used to represent N object nodes, where the first graph structure data indicate connectivity relationships mined for the N object nodes; the first graph structure data and node traffic data are processed by using a first graph neural network to obtain N first embedded representations of the N object nodes, where the node traffic data include T traffic values of each object node at T time points; second graph structure data and the node traffic data are processed by using a second graph neural network to obtain N second embedded representations of the N object nodes, where the second graph structure data indicate original connectivity relationships pre-generated for the N object nodes; fusion processing is performed based on the N first embedded representations and the N second embedded representations to obtain a fused representation matrix; the fused representation matrix and the T traffic values are processed by using the temporal sequence network, and a predicted traffic value of each object node at a time point after the T time points is determined; and parameters in the traffic prediction system are updated based on the predicted traffic value and a corresponding actual traffic value.

In some embodiments, business objects corresponding to the N object nodes are application software, and traffic is data traffic; or the business objects are points of interest (POIs), and the traffic is a road traffic.

In an embodiment, first graph structure data are generated based on node representation parameters in the graph generation module that are used to represent N object nodes, including following: A similarity matrix is determined based on the node representation parameters, where a matrix element in an i^{th} row and a j^{th} column represents a similarity between an i^{th} object node and a j^{th} object node; and the first graph structure data are determined based on the similarity matrix.

In an embodiment, the first graph structure data are determined based on the similarity matrix, including following: Sparse processing is performed on the similarity matrix to obtain the first graph structure data.

In a specific embodiment, the sparse processing includes following: The similarity matrix is processed by using a Gumbel-softmax function.

In an embodiment, the traffic prediction system further includes a first self-attention network and a second self-attention network, where fusion processing is performed based on the N first embedded representations and the N second embedded representations to obtain a fused representation matrix, including following: the N first embedded representations are inputted into the first self-attention network together to obtain N first encoded vectors; the N second embedded representations are inputted into the second self-attention network together to obtain N second encoded vectors; and fusion processing is performed on a first encoded vector and a second encoded vector corresponding to a same object node to obtain a fused vector, so as to form the fused representation matrix.

In an embodiment, the fused representation matrix and the T traffic values are processed by using the temporal sequence network, and a predicted traffic value of each object node at a time point after the T time points is determined, including following: T traffic data determined based on the T traffic values are sequentially inputted into the temporal sequence network, and the inputs are processed in the temporal sequence network by using the fused representation matrix, to obtain the predicted traffic value.

In a specific embodiment, t^{th} traffic data among the T traffic data include a sequence formed by a first traffic value to a t^{th} traffic value among the T traffic values in time sequence.

In a specific embodiment, the inputs are processed in the temporal sequence network by using the fused representation matrix, including following: At a hidden layer of the temporal sequence network, linear transformation processing is performed on traffic data inputted at a current time point and a hidden layer state at a previous time point by using the fused representation matrix, and a current hidden layer state is determined based on a result of the linear transformation processing and the hidden layer state at the previous time point.

Further, in a more specific embodiment, a current hidden layer state is determined, including following: Nonlinear activation processing is performed on the result of the linear transformation processing, and the current hidden layer state is determined based on a result of the activation processing and the hidden layer state at the previous time point.

According to a second aspect, a method for updating an index prediction system is provided, where the index prediction system includes a graph generation module, a temporal sequence network, and two graph neural networks, and the method includes following: first graph structure data are generated based on node representation parameters in the graph generation module that are used to represent N object nodes, where the first graph structure data indicate connectivity relationships mined for the N object nodes; the first graph structure data and node index data are processed by using a first graph neural network to obtain N first embedded representations of the N object nodes, where the node index data include T index values of each object node at T time points; second graph structure data and the node index data are processed by using a second graph neural network to obtain N second embedded representations of the N object nodes, where the second graph structure data indicate original connectivity relationships pre-generated for the N object nodes; fusion processing is performed based on the N first embedded representations and the N second embedded representations to obtain a fused representation matrix; the fused representation matrix and the T index values are processed by using the temporal sequence network, and a predicted index value of each object node at a time point after the T time points is determined; and parameters in the index prediction system are updated based on the predicted index value and a corresponding real index value.

In an embodiment, business objects corresponding to the N object nodes are users or products, and an index is a transaction amount or a number of transactions.

According to a third aspect, an apparatus for updating a traffic prediction system is provided, where the traffic prediction system includes a graph generation module, a temporal sequence network, and two graph neural networks, and the apparatus includes: a graph data generation unit, configured to generate first graph structure data based on node representation parameters in the graph generation module that are used to represent N object nodes, where the first graph structure data indicate connectivity relationships mined for the N object nodes; a first graph embedding unit, configured to process the first graph structure data and node traffic data by using a first graph neural network to obtain N first embedded representations of the N object nodes, where the node traffic data include T traffic values of each object node at T time points; a second graph embedding unit, configured to process second graph structure data and the node traffic data by using a second graph neural network to obtain N second embedded representations of the N object nodes, where the second graph structure data indicate original connectivity relationships pre-generated for the N object nodes; a representation fusion unit, configured to perform fusion processing based on the N first embedded representations and the N second embedded representations to obtain a fused representation matrix; a traffic prediction unit, configured to process the fused representation matrix and the T traffic values by using the temporal sequence network, and determine a predicted traffic value of each object node at a time point after the T time points; and a parameter updating unit, configured to update parameters in the traffic prediction system based on the predicted traffic value and a corresponding actual traffic value.

According to a fourth aspect, an apparatus for updating an index prediction system is provided, where the index prediction system includes a graph generation module, a temporal sequence network, and two graph neural networks, and the apparatus includes: a graph data generation unit, configured to generate first graph structure data based on node representation parameters in the graph generation module that are used to represent N object nodes, where the first graph structure data indicate connectivity relationships mined for the N object nodes; a first graph embedding unit, configured to process the first graph structure data and node index data by using a first graph neural network to obtain N first embedded representations of the N object nodes, where the node index data include T index values of each object node at T time points; a second graph embedding unit, configured to process second graph structure data and the node index data by using a second graph neural network to obtain N second embedded representations of the N object nodes, where the second graph structure data indicate original connectivity relationships pre-generated for the N object nodes; a representation fusion unit, configured to perform fusion processing based on the N first embedded representations and the N second embedded representations to obtain a fused representation matrix; an index prediction unit, configured to process the fused representation matrix and the T index values by using the temporal sequence network, and determine a predicted index value of each object node at a time point after the T time points; and a parameter updating unit, configured to update parameters in the index prediction system based on the predicted index value and a corresponding real index value.

According to a fifth aspect, a computer-readable storage medium is provided, where a computer program is stored in the computer-readable storage medium, and when the computer program is executed on a computer, the computer is enabled to perform the method according to the first aspect or the second aspect.

According to a sixth aspect, a computing device is provided, including a memory and a processor, where executable code is stored in the memory, and when the processor executes the executable code, the method according to the first aspect or the second aspect is implemented.

By using the methods and apparatuses according to some embodiments of this specification, explicit graph structure data determined based on prior knowledge are fused with mined implicit graph structure data, and a fusion result is used to predict indexes such as traffic, so that accuracy of results of prediction of indexes such as traffic can be effectively improved.

### BRIEF DESCRIPTION OF DRAWINGS

To describe the technical solutions in the embodiments of this application more clearly, the following briefly describes the accompanying drawings needed for describing the embodiments. Clearly, the accompanying drawings in the following descriptions show merely some embodiments of this application, and a person of ordinary skill in the art can still derive other accompanying drawings from these accompanying drawings without creative efforts.

FIG. 1 is an implementation architecture diagram illustrating a method for updating a traffic prediction system, according to some embodiments of this specification;

FIG. 2 is a schematic flowchart illustrating a method for updating a traffic prediction system, according to some embodiments of this specification;

FIG. 3 is a schematic flowchart illustrating a method for updating an index prediction system, according to some embodiments of this specification;

FIG. 4 is a schematic structural diagram illustrating an apparatus for updating a traffic prediction system, according to some embodiments of this specification; and

FIG. 5 is a schematic structural diagram illustrating an apparatus for updating an index prediction system, according to some embodiments of this specification.

### DESCRIPTION OF EMBODIMENTS

The solutions provided in this specification are described below with reference to the accompanying drawings.

As described above, there is need for a solution that can improve accuracy of multivariate time series prediction results. It can be understood that there are usually some correlations between multiple business variables (or referred to as business objects, objects or entities) involved in a specific service scenario, and business variables with correlations have similar data patterns. Therefore, it is desired that the correlations can be used to predict values of business variables. Usually, multiple business objects are used as multiple graph nodes (or referred to as multiple object nodes in this specification), and an edge is established to connect two graph nodes that have a correlation with each other, thereby forming a relationship network graph representing the correlations between the business objects. In addition, a storage form of connectivity relationships (or correlations) in a relationship network graph is usually an adjacency matrix (or referred to as graph structure data). For example, if an element in the i^{th} row and the j^{th} column in an adjacency matrix of a relationship network graph including N object nodes has an element value 0, it means that there is no connection edge between the i^{th} node and the j^{th} node, or there is no correlation; or if the element value is 1, it means that there is a connection edge, or there is a correlation.

It can be understood that more accurate obtained graph structure data indicate a more accurate business variable value prediction result. However, graph structure data (or referred to as a prior graph structure or an explicit graph structure here) actually determined in advance based on expert experience are often incomplete and have certain limitations. For example, in a service scenario where traffic flows of multiple roads are predicted, it can be manually and quickly determined that there is a correlation between two roads that are connected to each other. However, there are further many other road attributes that may be missed or difficult to accurately evaluate and can also affect a similarity between road traffic. For example, if two roads that are not connected to each other or even far away from each other have the same number of lanes and there are gas stations and schools along the roads, traffic patterns of the two roads are likely to be similar, so there is a correlation.

Further, it is proposed to use machine learning technology to comprehensively and accurately mine graph structure data between multiple object nodes. However, only relying on the mined graph structure data (or referred to as an implicit graph structure here) and discarding prior graph structure data with limitations but high accuracy also results in limited accuracy of finally obtained multivariate time series prediction results. Therefore, considering the utilization of the mined graph structure data and the prior graph structure data, how to effectively fuse the mined graph structure data and the prior graph structure data has triggered new challenges.

Through the above-mentioned observation and analysis, the inventor has designed a novel traffic prediction system, and put forward a training scheme for the traffic prediction system, so as to achieve effective fusion and use of the above-mentioned two-part graph structure data, and achieve accurate prediction of multiple traffic variables corresponding to multiple business objects.

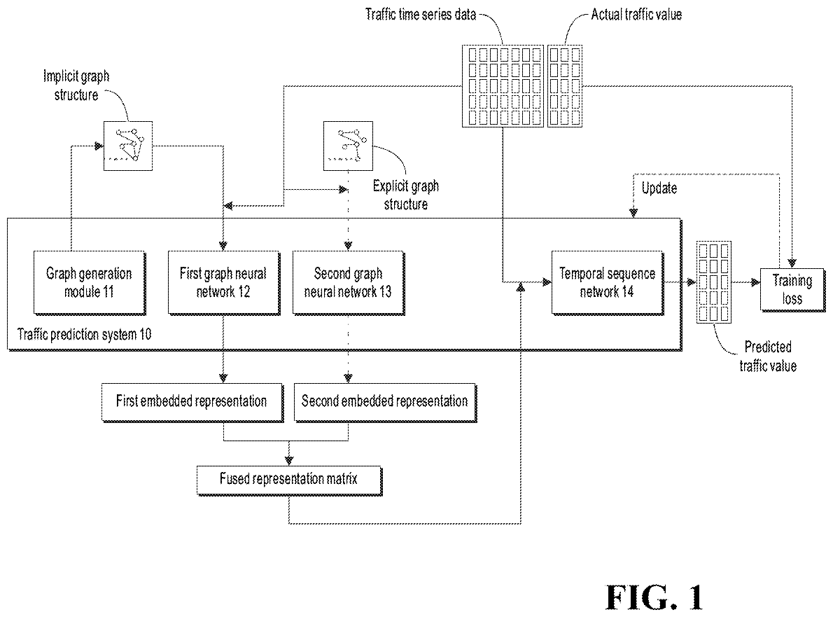

FIG. 1 is an implementation architecture diagram illustrating a method for updating a traffic prediction system, according to some embodiments of this specification. As shown in FIG. 1, a graph generation module 11, a first graph neural network 12, a second graph neural network 13 and a temporal sequence network 14 are designed in the traffic prediction system 10. In a training stage of the traffic prediction system 10, first the graph generation module 11 is used to mine connectivity relationships between N object nodes as implicit structure graph data; then the first graph neural network 12 is used to process the implicit graph structure data and traffic time series data of the N object nodes to obtain N first embedded representations of the N object nodes, and the second graph neural network 13 is used to process predetermined explicit graph structure data and the traffic time series data to obtain N second embedded representations of the N object nodes; then the two-part embedded representations are fused to obtain a fused representation matrix; then the temporal sequence network 14 is used to process the fused representation matrix and the traffic time series data to obtain predicted traffic values of the N object nodes at subsequent time points, and thus a training loss is determined based on the predicted traffic values and corresponding actual traffic values, to update parameters in the traffic prediction system 10. It can be understood that the parameters of the traffic prediction system include hyperparameters and optimizable parameters, values of the former are set manually, and values of the latter can be continuously and automatically determined, adjusted, updated or optimized during the model training. In this way, iterative training of the traffic prediction system 10 can be achieved.

Implementation steps of the above-mentioned solution are described below with reference to more embodiments.

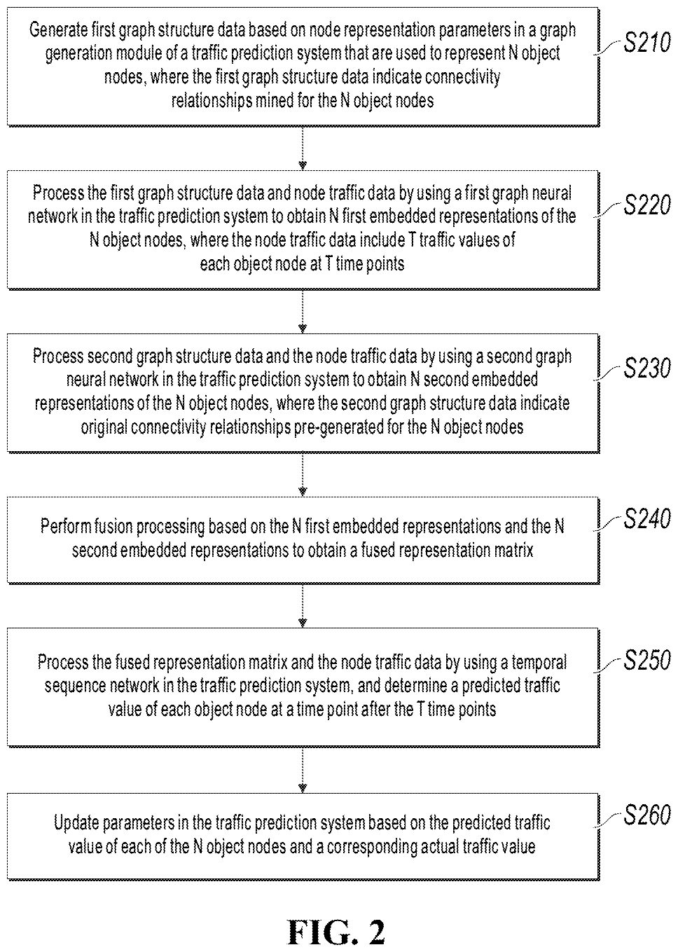

FIG. 2 is a schematic flowchart illustrating a method for updating a traffic prediction system, according to some embodiments of this specification. An execution subject of the method can be any server, apparatus, platform or device cluster, etc. with computing and processing capabilities. As shown in FIG. 2, the method includes the following steps.

Step S210: First graph structure data are generated based on node representation parameters in the graph generation module of the traffic prediction system that are used to represent N object nodes, where the first graph structure data indicate connectivity relationships mined for the N object nodes.

To facilitate understanding, N object nodes are first described. N is an integer greater than 1, and the N object nodes correspond to N business objects. In an embodiment, the N business objects are N pieces of application software. In another embodiment, the N business objects are N application pages, and the N application pages pertain to the same application software or pertain to different application software. In still another embodiment, the N business objects are N servers or N device clusters. In these embodiments of this paragraph, traffic of the business objects can be data traffic.

In yet another embodiment, the N business objects can be N points of interest (POIs). For example, the POIs can be roads, shops, stations, etc. In this case, the traffic can be road traffic, human traffic of shops, human traffic of stations, etc.

Further, node representation parameters for the above-mentioned N object nodes are configured in the graph generation module (references can be made to the graph generation module 11 in FIG. 1), and the module is configured to achieve a function of mining implicit connectivity relationships, which are also referred to as first graph structure data, between the N object nodes by processing the node representation parameters. The node representation parameters are set as updatable and optimizable parameters, that is, parameters that need to be adjusted during training.

A principle of mining an implicit graph structure is mainly that sufficiently similar object nodes usually have similar traffic patterns, so that there are correlations, and connection edges can be established. Based on this, this step can be implemented as follows: A similarity matrix is first determined based on the node representation parameters, where a matrix element in an i^{th} row and a j^{th} column represents a similarity between an i^{th} object node and a j^{th} object node; and then the first graph structure data are determined based on the similarity matrix.

In an embodiment, a mathematical form of the node representation parameters is an N*N-dimensional representing parameter matrix, and N rows or N columns in the matrix are N representing parameter vectors corresponding to the above-mentioned N object nodes. In this case, the similarity matrix can be calculated by the following equation:

θ=EE^{T} (1),

where θ represents the similarity matrix, E represents the above-mentioned N*N-dimensional representing parameter matrix, and T represents a transpose operator.

In this way, the similarity matrix θ can be determined. Further, in an embodiment, the similarity matrix θ can be directly used as the above-mentioned first graph structure data. In another embodiment, considering that the similarity matrix θ is very dense, which means that the similarity matrix contains a lot of redundant information, it is proposed to perform sparse processing on the similarity matrix θ to remove the redundant information contained in the similarity matrix, so as to improve accuracy of subsequent calculation and reduce a calculated amount.

In a specific embodiment, matrix elements in the similarity matrix θ can be randomly set to zero, however, this method may eliminate some effective information. In another specific embodiment, a Gumbel-softmax function is introduced to process the similarity matrix θ, so as to remove redundant information and useless noise information and fully retain effective information, and obtain a sparse, discrete and more interpretable graph structure as the above-mentioned first graph structure data. For example, using the Gumbel-softmax function to process the similarity matrix θ can be achieved by calculating the following equation:

A^{(l)}=σ((log(θᵢⱼ/(1−θᵢⱼ))+(gᵢⱼ¹−gᵢⱼ²))/s) s.t. gᵢⱼ¹, gᵢⱼ²˜Gumbel(0,1) (2),

where A^{(l)} represents the first graph structure data, θᵢⱼ represents the element in the ith row and the jth column of the similarity matrix θ; σ represents a softmax function; gᵢⱼ¹ and gᵢⱼ² represent sampling results obtained for θᵢⱼ by sampling twice from Gumbel(0, 1) distribution; the symbol s.t. indicates being bound to; s represents a temperature parameter, which can be a hyperparameter set manually, and a smaller value of the hyperparameter s indicates higher tendency of elements in A^{(l)} to be polarized, that is, the value is closer to 0 or 1.

From the above, the graph generation module can be used to mine the first graph structure data. Therefore, in step S220, the first graph structure data and node traffic data are processed by using a first graph neural network in the traffic prediction system to obtain N first embedded representations of the N object nodes.

It is worthwhile to note that the above-mentioned node traffic data include T traffic values of each object node at T time points. Specifically, traffic data of each of the above-mentioned N object nodes at multiple historical time points can be collected, and then are intercepted based on a length (denoted as T time points here) of a training sample and a length (denoted as τ time points here) of a label to obtain multiple training samples and labels corresponding to the training samples. For example, it is assumed that traffic data of a certain node at 15 historical time points are collected, and values of T and τ are 6 and 2, respectively. In this case, a sliding window with a length of 8 can be used to perform sliding window processing on a traffic sequence with a length of 15 to obtain (15−8+1)=8 traffic subsequences, and the first 6 of each traffic subsequence are used to form training samples, while the last 2 are used to form corresponding traffic labels. In this way, node traffic data and corresponding traffic labels of the N object nodes can be obtained. It can be understood that T is an integer greater than 1, and τ is a positive integer.

Based on this, the first graph neural network (references can be made to the first graph neural network 12 in FIG. 1) can be used to process the obtained node traffic data and the mined first graph structure data. It can be understood that graph neural networks (GNNs) are suitable for processing graph data, including graph embedding processing based on graph structure data of a relationship network graph and original features of graph nodes, so as to obtain node representations or graph representations with spatial structure information of the relationship network graph.

Further, the above-mentioned node traffic data can be classified as the original features of the graph nodes. Specifically, original features of each object node include T traffic values of the object node at the above-mentioned T time points. It should be understood that the original features of the node can further include other features besides the traffic data. In an example, a business object represented by the node is a road. In this case, the original features can further include acquisition time periods (such as morning, afternoon or evening) of the traffic data, business circles along the road, etc. In another example, the business object represented by the node is application software. In this case, the original features can further include a name of a service provided by the application software, interface contents in the application software, etc.

Therefore, the first graph neural network can be used to process the above-mentioned first graph structure data and the original features of each object node. In an embodiment, the first graph neural network can be implemented as a graph convolutional network (GCN), a graph attention network (GAT), etc. For example, the first graph neural network is implemented as a GCN, and accordingly, this step can be implemented by calculating the following equation:

$${\tilde{A}}^{( l )} ( X ) = ( I + {D}^{- \frac{1}{2}} {A}^{( l )} {D}^{- \frac{1}{2}} ) {XW}^{( l )} + {W}_{b}^{( l )} , \qquad ( 3 )$$

where Ã^{(l)}(X) represents a first representation matrix composed of N first embedded representations of the N object nodes; I represents an identity matrix; and D represents a degree matrix corresponding to the first graph structure data; it can be understood that an i^{th} diagonal element in the degree matrix indicates a number of first-order neighbor nodes of the i^{th} object node, and an off-diagonal element is 0; A^{(l)} represents the first graph structure data; X represents original features of N node objects, and for example, can be an N*T-dimensional traffic matrix, where vector elements in the i^{th} row are T traffic values of the i^{th} object node; and W^{(l)} and W_{b}^{(l)} represent network parameters in the first graph neural network.

In this way, N first embedded representations (or referred to as N first embedded vectors) of the N object nodes can be obtained in step S220.

Before or after step S220 is performed or while step S220 is being performed, step S230 can also be performed: Second graph structure data and the node traffic data are processed by using a second graph neural network in the traffic prediction system to obtain N second embedded representations of the N object nodes, where the second graph structure data indicate original connectivity relationships pre-generated for the N object nodes.

It should be understood that the second graph structure data are prior graph structure data. Implementation algorithms of the first graph neural network and the second graph neural network (references can be made to the second graph neural network 13 in FIG. 1) can be the same or different, for example, both are GCNs, or one is a GCN, and the other is a GAT. For example, the second graph neural network is implemented as a GCN, and accordingly, this step can be implemented by calculating the following equation:

$${\tilde{A}}^{( 0 )} ( X ) = ( I + {D}^{- \frac{1}{2}} {A}^{( 0 )} {D}^{- \frac{1}{2}} ) {XW}^{( 0 )} + {W}_{b}^{( 0 )} , \qquad ( 4 )$$

where Ã⁽⁰⁾(X) represents a second representation matrix composed of N second embedded representations of the N object nodes; I represents an identity matrix; and D represents a degree matrix corresponding to the second graph structure data; A⁽⁰⁾ represents the second graph structure data; X represents original features of N node objects, and for example, can be an N*T-dimensional traffic matrix, where vector elements in the i^{th} row are T traffic values of the i^{th} object node; and W⁽⁰⁾ and W_{b}⁽⁰⁾ represent network parameters in the first graph neural network.

It is worthwhile to note that for the description of step S230, references can also be made to the description of step S220.

In this way, N second embedded representations (or referred to as N second embedded vectors) of the N object nodes can be obtained in step S230.

After the N first embedded representations and the N second embedded representations of the N object nodes are obtained above, step S240 is performed: Fusion processing is performed on the two-part embedded representations to obtain a fused representation matrix.

In an embodiment, a self-attention mechanism can be first introduced to encode each embedded representation, and then fusion processing is performed on coding results to obtain a fused representation matrix. It can be understood that a self-attention module receives n inputs and then correspondingly returns n outputs; the “self” in the self-attention mechanism means that the inputs can interact with each other, and the “attention” means calculating n pieces of attention (which can be understood as a degree of attention) allocated to n inputs by each input, so that the n inputs can be weighted by the n pieces of attention corresponding to each input, and self-attention coding of each input can be achieved.

For self-attention coding, in a specific embodiment, the N first embedded representations are first inputted into the first self-attention network together to obtain N first encoded vectors, and the N second embedded representations are inputted into the second self-attention network together to obtain N second encoded vectors. For example, the two self-attention networks can be implemented as Transformer networks. In another specific embodiment, for each first embedded representation, N similarities between the first embedded representation and the N first embedded representations are calculated, and the N similarities are normalized as N attention weights, so that a result of weighted summation of the N first embedded representations by using the N attention weights is used as a first encoded vector corresponding to the first embedded representation; and similarly, a second encoded vector corresponding to each second embedded representation can be obtained.

After the N first encoded vectors and the N second encoded vectors are obtained above, fusion processing can be performed on a first encoded vector and a second encoded vector corresponding to the same object node to obtain a fused vector, so as to construct a fused representation matrix by using the N fused vectors. In a specific embodiment, the fusion processing can be performed by using fusion methods such as summation, averaging, and elementwise multiplication.

According to an example, two self-attention networks are introduced to achieve self-attention coding of embedded representations, and the fusion processing of coding results is achieved by summation. In this case, the implementation of this step can be denoted as the following equation:

M^{(m)}(X)=fₐ(Ã^{(l)}(X); θₐ)+f_{b}(Ã⁽⁰⁾(X); θ_{b}) (5),

where M^{(m)}(X) represents a fused representation matrix, and f a represents a first self-attention network; θₐ represents network parameters in the first self-attention network; Ã^{(l)}(X) represents a first representation matrix composed of N first embedded representations; f_{b} represents a second self-attention network; θ_{b} represents network parameters in the second self-attention network; and Ã⁽⁰⁾(X) represents a second representation matrix composed of N second embedded representations.

From the above, by introducing self-attention coding, a more comprehensive, high-order and accurate representation of a node traffic sequence can be achieved, thereby making information included in the fused representation matrix more in-depth and accurate.

In another embodiment, fusion processing can be directly performed on the N first embedded representations and the N second embedded representations without introducing the self-attention mechanism, including following: The fusion processing is performed on a first embedded representation and a second embedded representation corresponding to the same object node to obtain a fused vector, so as to construct a fused representation matrix by using the N fused vectors. In a specific embodiment, the fusion processing can be performed by using fusion methods such as summation, averaging, and elementwise multiplication.

From the above, the fused representation matrix can be obtained. It can be understood that the information contained in an explicit graph structure and an implicit graph structure is fused.

Then, in step S250, the fused representation matrix and the above-mentioned node traffic data are processed by using a temporal sequence network in the traffic prediction system, and a predicted traffic value of each object node at a time point after the T time points is determined.

Specifically, in this step, the above-mentioned temporal sequence network (references can be made to the temporal sequence network 14 in FIG. 1) can be used to process the above-mentioned fused representation matrix and T traffic data determined based on T traffic values of each object node. In an embodiment, any t^{th} traffic data among the T traffic data include a traffic sequence formed by a first traffic value to a t^{th} traffic value among the T traffic values in time sequence. In another specific embodiment, the T traffic values can be directly used as T traffic data.

It can be understood that the temporal sequence network, like other neural networks, includes an input layer, a hidden layer, and an output layer, and the hidden layer is configured to perform linear transformation and other processing on data inputted into the hidden layer. In addition, the temporal sequence network is configured to process time series data, and has a unique “memory function”, which is embodied in that when a hidden layer state at the current time point is calculated, not only the input of the input layer at the current time point is considered, but also the hidden state at the previous time point is considered.

Based on this, in the implementation of this step, it is designed to use the above-mentioned fused representation matrix to complete part or all of the linear transformation processing at the hidden layer, which includes at least linear transformation processing of traffic data inputted at the current time point, so as to determine the current hidden layer state based on a result of the linear transformation processing and the hidden layer state at the previous time point. Further, in an embodiment, the linear transformation processing further includes linear transformation performed on the hidden layer state at the previous time point by using the fused representation matrix. It can be understood that if it is designed to use the fused representation matrix to complete part of the linear transformation processing, the remaining of the linear transformation processing can be achieved by using a parameter matrix. The parameter matrix refers to a matrix whose components are optimizable parameters.

According to another aspect, in an embodiment, the above-mentioned determining of the current hidden layer state includes following: Nonlinear activation processing is performed on the above-mentioned result of the linear transformation processing, so that the current hidden layer state is determined based on a result of the activation processing and the hidden layer state at the previous time point.

According to an example, at the hidden layer of the temporal sequence network, it is designed to use the above-mentioned fused representation matrix to perform linear transformation processing in all multiplicative forms. In addition, the above-mentioned temporal sequence network is implemented based on a gated recurrent unit (GRU). In this case, the process of calculating, at the hidden layer, a hidden layer state hₜ at a current time point t based on traffic data Xₜ inputted at the current time point t and a hidden layer state hₜ₋₁ at a previous time point t−1 can be denoted as the following equation:

zₜ=σ(M^{(m)}([Xₜ, hₜ₋₁]))

rₜ=σ(M^{(m)}(|[Xₜ, hₜ₋₁]))

ĥₜ=tanh(M^{(m)}([rₜ⊙hₜ₋₁, Xₜ])

hₜ=zₜ⊙hₜ₋₁+(1−zₜ)⊙ĥₜ (6),

where σ represents an activation function; M^{(m)} represents the fused representation matrix; symbol [,] represents that two-part data before and after the comma in the brackets [ ] are spliced; ⊙ represents elementwise multiplication operation between tensors; and zₜ, rₜ and ĥₜ can be simply regarded as intermediate variables generated by the calculation process.

It can be understood that calculation expressions for zₜ and rₜ in equation (6) usually further involve other parameter items, respectively, such as bias matrixes, W_{z} and Wᵣ. In addition, the implementation of the temporal sequence network can be further based on a recurrent neural network (RNN), a long short-term memory (LSTM) network, etc.

In this way, the current hidden layer state hₜ₋₁ corresponding to the current time point t can be obtained, and by analogy, T hidden layer states corresponding to the above-mentioned T time points can be obtained. Further, at the output layer of the temporal sequence network, a predicted traffic value at the (t+1)^{th} time point after the T time points can be determined by using some or all of the T hidden layer states. For example, at the output layer, the hidden layer state h_{T} at the T^{th} time point undergoes dot product by using a parameter vector associated with this layer, and then a dot product result is processed by using a sigomid function to obtain a predicted traffic value.

It is worthwhile to note that continuing to determine a plurality of predicted traffic values at a plurality of time points (one or more) after T+1 time points can be implemented, and a specific number of the plurality of time points can be set based on actual needs. In addition, in this determination process, for a certain time point among the plurality of time points, a predicted traffic value outputted at the previous time point can be used as the input of the input layer, so as to obtain a predicted traffic value at the time point. For example, a predicted traffic value at the (T+1)^{th} time point can be used as the input of the input layer at the (T+1)^{th} time point, so as to determine the hidden layer state at the (T+1)^{th} time point at the hidden layer by using this input and the hidden layer state at the T^{th} time point, and then a predicted traffic value at the (T+2)^{th} time point is determined at the output layer based on the hidden layer state at the (T+1)^{th} time point.

From the above, a predicted traffic value (s) of each of the N object nodes at τ (one or more) time points after T time points can be determined. In addition, it is worthwhile to note that the graph generation module and a functional module configured to generate the fused representation matrix based on an explicit graph structure, an implicit graph structure and a node traffic sequence in the embodiments of this specification are universal and are agnostic to specific spatio-temporal prediction network structures, that is, the two modules can be applied to common spatio-temporal prediction networks, such as a classic STGCN and AGCRN.

Then, in step S260, parameters in the above-mentioned traffic prediction system are updated based on the predicted traffic value of each of the N object nodes and a corresponding actual traffic value (that is, the above-mentioned traffic label).

Specifically, for each object node, the training loss is determined by using the predicted traffic value of the object node and the corresponding actual traffic value. It can be understood that the predicted traffic value and the actual traffic value correspond to the same τ time points. In addition, the training loss can be calculated by using loss functions such as mean square error or mean absolute error. For example, the loss can be calculated by using the following equation:

$$ℒ ( {W}_{θ} ) = \frac{1}{τ} \vert {X}_{T + 1 : T + τ} - {\hat{X}}_{T + 1 : T + τ} \vert , \qquad ( 7 )$$

where L (W_{θ}) represents the training loss; W_{θ} represents optimizable parameters in the traffic prediction system; X_{T+1:T+τ} represents an actual traffic value from the (T+1)^{th} time point to the (T+τ)^{th} time point; and \hat{X}_{T+1:T+τ} represents a predicted traffic value from the (T+1)^{th} time point to the (T+τ)^{th} time point.

Further, based on the calculated training loss, the optimizable parameters in the traffic prediction system are updated by using a back propagation method.

From the above, the parameters of the traffic prediction system can be updated. Therefore, the above-mentioned method process can be repeatedly performed based on a training sample set, and the traffic prediction system can be updated iteratively for many times until a predetermined convergence standard is satisfied, for example, a number of iterations reaches a predetermined number of times, or the loss on a verification set is less than a predetermined threshold, so as to obtain a trained traffic prediction system for traffic prediction in an actual use stage.

In conclusion, by using the method for updating a traffic prediction system according to some embodiments of this specification, spatio-temporal prediction is performed based on prior explicit graph structure data and mined implicit graph structure data, and the time correlation and space dependence are considered, so that the accuracy of traffic prediction results can be effectively improved.

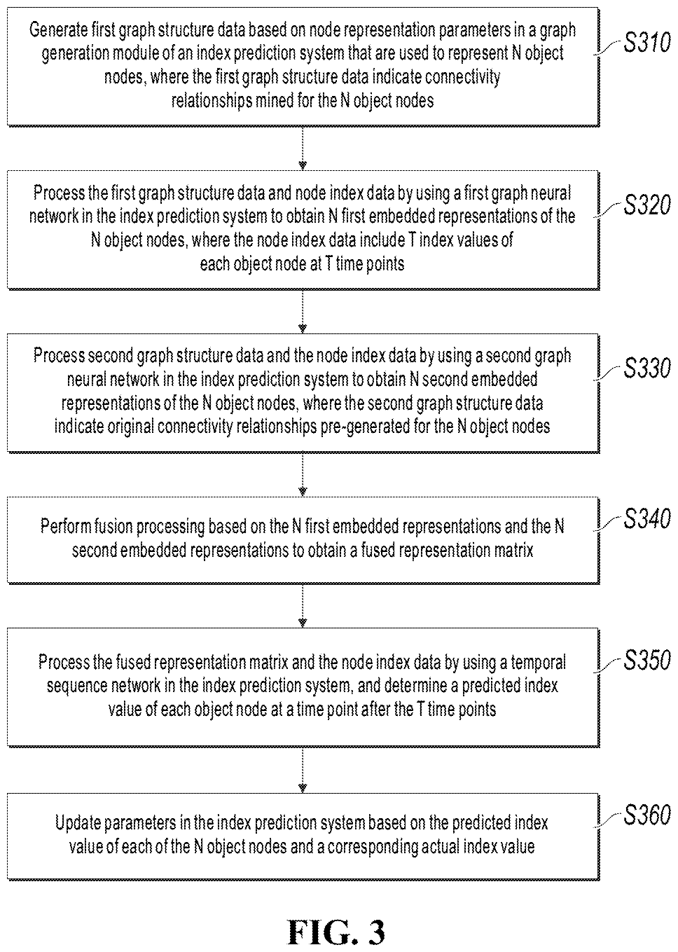

The above mainly describes the method for updating a traffic prediction system. Actually, this method can also be extended to prediction systems for other business indexes, such as a transaction amount, a number of transactions, and temperature. In this regard, FIG. 3 is a schematic flowchart illustrating a method for updating an index prediction system, according to some embodiments of this specification. An execution subject of the method can be any apparatus, platform, server or device cluster, etc. with computing and processing capabilities.

Similar to the above-mentioned traffic prediction system, the index prediction system includes a graph generation module, a temporal sequence network, and two graph neural networks. As shown in FIG. 3, the method includes the following steps.

Step S310: First graph structure data are generated based on node representation parameters in the graph generation module in the index prediction system that are used to represent N object nodes, where the first graph structure data indicate connectivity relationships mined for the N object nodes.

In an embodiment, business objects corresponding to the N object nodes are users (including individual users or enterprise users), and corresponding business indexes can be a transaction amount, a number of transactions, etc. In another embodiment, business objects corresponding to the N object nodes are products, and corresponding business indexes can be a click volume, a sales volume, etc. In still another embodiment, business objects corresponding to the N object nodes are events (such as transaction events, login events, and access events), and corresponding business indexes can be a success rate, a complaint rate, etc.

Step S320: The first graph structure data and node index data are processed by using a first graph neural network in the index prediction system to obtain N first embedded representations of the N object nodes, where the node index data include T index values of each object node at T time points.

Step S330: Second graph structure data and the node index data are processed by using a second graph neural network in the index prediction system to obtain N second embedded representations of the N object nodes, where the second graph structure data indicate original connectivity relationships pre-generated for the N object nodes.

Step S340: Fusion processing is performed based on the N first embedded representations and the N second embedded representations to obtain a fused representation matrix.

Step S350: The fused representation matrix and the T index values are processed by using the temporal sequence network in the index prediction system, and a predicted index value of each object node at a time point after the T time points is determined.

Step S360: Parameters in the index prediction system are updated based on the above-mentioned predicted index value and a corresponding real index value.

It is worthwhile to note that for the description of the steps in FIG. 3, references can also be made to the above-mentioned description of the steps in FIG. 2. Under reasonable circumstances, the word “index” can be directly used to replace the word “traffic”.

In conclusion, by using the method for updating an index prediction system according to some embodiments of this specification, explicit graph structure data determined based on prior knowledge are fused with mined implicit graph structure data, and a fusion result is used to predict indexes, so that accuracy of index prediction results can be effectively improved.

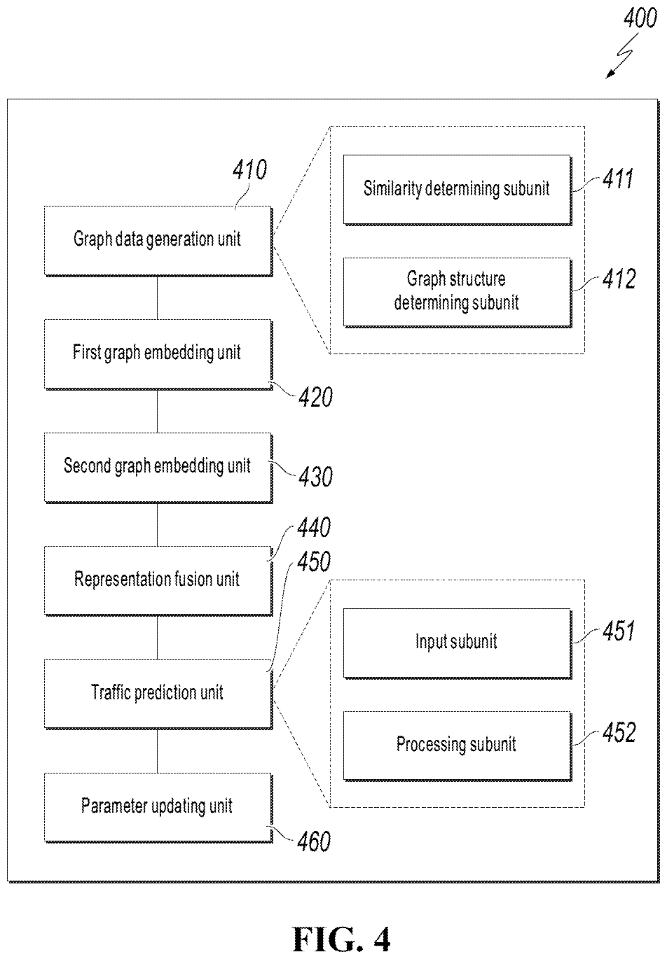

Corresponding to the above-mentioned method for updating a prediction system, some embodiments of this specification further disclose an apparatus for updating a prediction system. FIG. 4 is a schematic structural diagram illustrating an apparatus for updating a traffic prediction system, according to some embodiments of this specification. The traffic prediction system includes a graph generation module, a temporal sequence network, and two graph neural networks. The apparatus 400 includes: a graph data generation unit 410, configured to generate first graph structure data based on node representation parameters in the graph generation module that are used to represent N object nodes, where the first graph structure data indicate connectivity relationships mined for the N object nodes; a first graph embedding unit 420, configured to process the first graph structure data and node traffic data by using a first graph neural network to obtain N first embedded representations of the N object nodes, where the node traffic data include T traffic values of each object node at T time points; a second graph embedding unit 430, configured to process second graph structure data and the node traffic data by using a second graph neural network to obtain N second embedded representations of the N object nodes, where the second graph structure data indicate original connectivity relationships pre-generated for the N object nodes; a representation fusion unit 440, configured to perform fusion processing based on the N first embedded representations and the N second embedded representations to obtain a fused representation matrix; a traffic prediction unit 450, configured to process the fused representation matrix and the T traffic values by using the temporal sequence network, and determine a predicted traffic value of each object node at a time point after the T time points; and a parameter updating unit 460, configured to update parameters in the traffic prediction system based on the predicted traffic value and a corresponding actual traffic value.

In an embodiment, business objects corresponding to the N object nodes are application software, and traffic is data traffic; or the business objects are points of interest (POIs), and the traffic is a road traffic.

In an embodiment, the graph data generation unit 410 includes: a similarity determining subunit 411, configured to determine a similarity matrix based on the node representation parameters, where a matrix element in an i^{th} row and a j^{th} column represents a similarity between an i^{th} object node and a j^{th} object node; and a graph structure determining subunit 412, configured to determine the first graph structure data based on the similarity matrix.

In a specific embodiment, the graph structure determining subunit 412 is specifically configured to perform sparse processing on the similarity matrix to obtain the first graph structure data.

In a more specific embodiment, the graph structure determining subunit 412 is further configured to process the similarity matrix by using a Gumbel-softmax function to obtain the first graph structure data.

In an embodiment, the traffic prediction system further includes a first self-attention network and a second self-attention network, where the representation fusion unit 440 is specifically configured to input the N first embedded representations into the first self-attention network together to obtain N first encoded vectors; input the N second embedded representations into the second self-attention network together to obtain N second encoded vectors; and perform fusion processing on a first encoded vector and a second encoded vector corresponding to a same object node to obtain a fused vector, so as to form the fused representation matrix.

In an embodiment, the traffic prediction unit 450 includes: an input subunit 451, configured to sequentially input T traffic data determined based on the T traffic values into the temporal sequence network; and a processing subunit 452, configured to process the inputs in the temporal sequence network by using the fused representation matrix, to obtain the predicted traffic value.

In a specific embodiment, t^{th} traffic data among the T traffic data include a sequence formed by a first traffic value to a t^{th} traffic value among the T traffic values in time sequence.

In a specific embodiment, the processing subunit 452 is specifically configured to perform, at a hidden layer of the temporal sequence network, linear transformation processing on traffic data inputted at a current time point and a hidden layer state at a previous time point by using the fused representation matrix, and determine a current hidden layer state based on a result of the linear transformation processing and the hidden layer state at the previous time point.

In a more specific embodiment, the processing subunit 452 is further configured to perform nonlinear activation processing on the result of the linear transformation processing, and determine the current hidden layer state based on a result of the activation processing and the hidden layer state at the previous time point.

In conclusion, by using the apparatus for updating a traffic prediction system according to some embodiments of this specification, explicit graph structure data determined based on prior knowledge are fused with mined implicit graph structure data, and a fusion result is used to predict traffic, so that accuracy of traffic prediction results can be effectively improved.

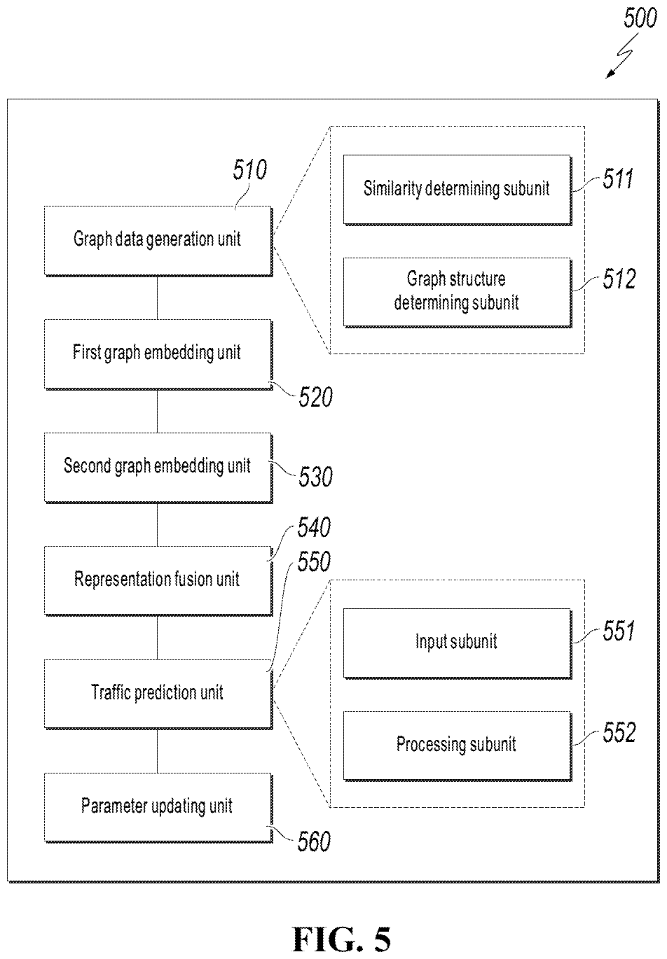

FIG. 5 is a schematic structural diagram illustrating an apparatus for updating an index prediction system, according to some embodiments of this specification. The index prediction system includes a graph generation module, a temporal sequence network, and two graph neural networks. As shown in FIG. 5, the apparatus 500 includes a graph data generation unit 510, configured to generate first graph structure data based on node representation parameters in the graph generation module that are used to represent N object nodes, where the first graph structure data indicate connectivity relationships mined for the N object nodes; a first graph embedding unit 520, configured to process the first graph structure data and node index data by using a first graph neural network to obtain N first embedded representations of the N object nodes, where the node index data include T index values of each object node at T time points; a second graph embedding unit 530, configured to process second graph structure data and the node index data by using a second graph neural network to obtain N second embedded representations of the N object nodes, where the second graph structure data indicate original connectivity relationships pre-generated for the N object nodes; a representation fusion unit 540, configured to perform fusion processing based on the N first embedded representations and the N second embedded representations to obtain a fused representation matrix; an index prediction unit 550, configured to process the fused representation matrix and the T index values by using the temporal sequence network, and determine a predicted index value of each object node at a time point after the T time points; and a parameter updating unit 560, configured to update parameters in the index prediction system based on the predicted index value and a corresponding real index value.

In an embodiment, business objects corresponding to the N object nodes are users (including individual users or enterprise users), and corresponding business indexes can be a transaction amount, a number of transactions, etc. In another embodiment, business objects corresponding to the N object nodes are products, and corresponding business indexes can be a click volume, a sales volume, a transaction amount, a number of transactions, etc. In still another embodiment, business objects corresponding to the N object nodes are events (such as transaction events, login events, and access events), and corresponding business indexes can be a success rate, a complaint rate, etc.

In an embodiment, the graph data generation unit 510 includes: a similarity determining subunit 511, configured to determine a similarity matrix based on the node representation parameters, where a matrix element in an i^{th} row and a j^{th} column represents a similarity between an i^{th} object node and a j^{th} object node; and a graph structure determining subunit 512, configured to determine the first graph structure data based on the similarity matrix.

In a specific embodiment, the graph structure determining subunit 512 is specifically configured to perform sparse processing on the similarity matrix to obtain the first graph structure data.

In a more specific embodiment, the graph structure determining subunit 512 is further configured to process the similarity matrix by using a Gumbel-softmax function to obtain the first graph structure data.

In an embodiment, the index prediction system further includes a first self-attention network and a second self-attention network, where the representation fusion unit 540 is specifically configured to input the N first embedded representations into the first self-attention network together to obtain N first encoded vectors; input the N second embedded representations into the second self-attention network together to obtain N second encoded vectors; and perform fusion processing on a first encoded vector and a second encoded vector corresponding to a same object node to obtain a fused vector, so as to form the fused representation matrix.

In an embodiment, the index prediction unit 550 includes: an input subunit 551, configured to sequentially input T index data determined based on the T index values into the temporal sequence network; and a processing subunit 552, configured to process the inputs in the temporal sequence network by using the fused representation matrix, to obtain the predicted index value.

In a specific embodiment, t^{th} index data among the T index data include a sequence formed by a first index value to a t^{th} index value among the T index values in time sequence.

In a specific embodiment, the processing subunit 552 is specifically configured to perform, at a hidden layer of the temporal sequence network, linear transformation processing on index data inputted at a current time point and a hidden layer state at a previous time point by using the fused representation matrix, and determine a current hidden layer state based on a result of the linear transformation processing and the hidden layer state at the previous time point.

In a more specific embodiment, the processing subunit 552 is further configured to perform nonlinear activation processing on the result of the linear transformation processing, and determine the current hidden layer state based on a result of the activation processing and the hidden layer state at the previous time point.

In conclusion, by using the apparatuses for updating an index prediction system according to some embodiments of this specification, explicit graph structure data determined based on prior knowledge are fused with mined implicit graph structure data, and a fusion result is used to predict business indexes, so that accuracy of index prediction results can be effectively improved.

According to some embodiments of another aspect, a computer-readable storage medium is further provided, where a computer program is stored in the computer-readable storage medium, and when the computer program is executed in a computer, the computer is enabled to perform the method described with reference to FIG. 2 or FIG. 3.

According to some embodiments of still another aspect, a computing device is further provided, including a memory and a processor. Executable code is stored in the memory, and when the processor executes the executable code, the method described with reference to FIG. 2 or FIG. 3 is implemented. A person skilled in the art should be aware that in the above-mentioned one or more examples, functions described in this application can be implemented by hardware, software, firmware, or any combination thereof. When being implemented by software, these functions can be stored in a computer-readable medium or transmitted as one or more instructions or code in the computer-readable medium.

The objectives, technical solutions, and beneficial effects of this application are further described in detail in the above-mentioned specific implementations. It should be understood that the above described are only specific implementations of this application and are not intended to limit the protection scope of this application. Any modification, equivalent replacement, improvement, etc. made based on the technical solutions of this application should fall within the protection scope of this application.

What is claimed is:

1. A computer-implemented method for updating a traffic prediction system, comprising:
generating, using a graph generation module and based on node representation parameters in the graph generation module that are used to represent N object nodes, first graph structure data, wherein the first graph structure data indicates connectivity relationships mined for the N object nodes;
processing, using a first graph neural network, the first graph structure data and node traffic data to obtain N first embedded representations of the N object nodes, wherein the node traffic data comprises T traffic values of each object node at T time points;
processing, using a second graph neural network, second graph structure data and the node traffic data to obtain N second embedded representations of the N object nodes, wherein the second graph structure data indicates original connectivity relationships pre-generated for the N object nodes;
performing, based on the N first embedded representations and the N second embedded representations, fusion processing to obtain a fused representation matrix;
processing, using a temporal sequence network, the fused representation matrix and the T traffic values of each object node at T time points, and determining a predicted traffic value of each object node at a time point after the T time points; and
updating parameters in the traffic prediction system based on the predicted traffic value of each object node at a time point after the T time points and a corresponding actual traffic value.

2. The computer-implemented method of claim 1, wherein:
business objects corresponding to the N object nodes are application software and traffic is data traffic; or
the business objects are points of interest (POIs), and the traffic is a road traffic.

3. The computer-implemented method of claim 1, wherein generating, using a graph generation module and based on node representation parameters in the graph generation module that are used to represent N object nodes, first graph structure data, comprises:
determining, based on the node representation parameters, a similarity matrix, wherein a matrix element in an i^{th} row and a j^{th} column represents a similarity between an i^{th} object node and a j^{th} object node; and
determining, based on the similarity matrix, the first graph structure data.

4. The computer-implemented method of claim 3, wherein determining, based on the similarity matrix, the first graph structure data, comprises:
performing sparse processing on the similarity matrix to obtain the first graph structure data.

5. The computer-implemented method of claim 4, wherein the sparse processing, comprises:
processing the similarity matrix by using a Gumbel-softmax function.

6. The computer-implemented method of claim 1, wherein performing, based on the N first embedded representations and the N second embedded representations, fusion processing to obtain a fused representation matrix, comprises:
inputting the N first embedded representations into a first self-attention network together to obtain N first encoded vectors;
inputting the N second embedded representations into a second self-attention network together to obtain N second encoded vectors; and
performing fusion processing on a first encoded vector and a second encoded vector corresponding to a same object node to obtain a fused vector to form the fused representation matrix.

7. The computer-implemented method of claim 1, wherein processing, using the temporal sequence network, the fused representation matrix and the T traffic values of each object node at T time points, and determining a predicted traffic value of each object node at a time point after the T time points, comprises:
sequentially inputting T traffic data determined based on the T traffic values of each object node at T time points into the temporal sequence network, wherein t^{th} traffic data among the T traffic data comprises a sequence formed by a first traffic value to a t^{th} traffic value among the T traffic values in time sequence; and
processing, using the fused representation matrix, inputs in the temporal sequence network to obtain the predicted traffic value of each object node at a time point after the T time points.

8. The computer-implemented method of claim 7, wherein processing, using the fused representation matrix, inputs in the temporal sequence network to obtain the predicted traffic value of each object node at a time point after the T time points, comprises:
performing, at a hidden layer of the temporal sequence network and using the fused representation matrix, linear transformation processing on traffic data inputted at a current time point and a hidden layer state at a previous time point; and
determining, based on a result of the linear transformation processing and the hidden layer state at the previous time point, a current hidden layer state.

9. The computer-implemented method of claim 8, wherein determining, based on a result of the linear transformation processing and the hidden layer state at the previous time point, a current hidden layer state, comprises:
performing nonlinear activation processing on the result of the linear transformation processing; and
determining, based on a result of the nonlinear activation processing and the hidden layer state at the previous time point, the current hidden layer state.

10. A non-transitory, computer-readable medium storing one or more instructions executable by a computer system to perform one or more operations for updating a traffic prediction system, comprising:
generating, using a graph generation module and based on node representation parameters in the graph generation module that are used to represent N object nodes, first graph structure data, wherein the first graph structure data indicates connectivity relationships mined for the N object nodes;
processing, using a first graph neural network, the first graph structure data and node traffic data to obtain N first embedded representations of the N object nodes, wherein the node traffic data comprises T traffic values of each object node at T time points;
processing, using a second graph neural network, second graph structure data and the node traffic data to obtain N second embedded representations of the N object nodes, wherein the second graph structure data indicates original connectivity relationships pre-generated for the N object nodes;
performing, based on the N first embedded representations and the N second embedded representations, fusion processing to obtain a fused representation matrix;
processing, using a temporal sequence network, the fused representation matrix and the T traffic values of each object node at T time points, and determining a predicted traffic value of each object node at a time point after the T time points; and
updating parameters in the traffic prediction system based on the predicted traffic value of each object node at a time point after the T time points and a corresponding actual traffic value.

11. The non-transitory, computer-readable medium of claim 10, wherein:
business objects corresponding to the N object nodes are application software and traffic is data traffic; or
the business objects are points of interest (POIs), and the traffic is a road traffic.

12. The non-transitory, computer-readable medium of claim 10, wherein generating, using a graph generation module and based on node representation parameters in the graph generation module that are used to represent N object nodes, first graph structure data, comprises one or more instructions for:
determining, based on the node representation parameters, a similarity matrix, wherein a matrix element in an i^{th} row and a j^{th} column represents a similarity between an i^{th} object node and a j^{th} object node; and
determining, based on the similarity matrix, the first graph structure data.

13. The non-transitory, computer-readable medium of claim 12, wherein determining, based on the similarity matrix, the first graph structure data, comprises one or more instructions for:
performing sparse processing on the similarity matrix to obtain the first graph structure data.

14. The non-transitory, computer-readable medium of claim 13, wherein the sparse processing, comprises one or more instructions for:
processing the similarity matrix by using a Gumbel-softmax function. The non-transitory, computer-readable medium of claim 10, wherein performing, based on the N first embedded representations and the N second embedded representations, fusion processing to obtain a fused representation matrix, comprises one or more instructions for:
inputting the N first embedded representations into a first self-attention network together to obtain N first encoded vectors;
inputting the N second embedded representations into a second self-attention network together to obtain N second encoded vectors; and
performing fusion processing on a first encoded vector and a second encoded vector corresponding to a same object node to obtain a fused vector to form the fused representation matrix.

16. The non-transitory, computer-readable medium of claim 10, wherein processing, using the temporal sequence network, the fused representation matrix and the T traffic values of each object node at T time points, and determining a predicted traffic value of each object node at a time point after the T time points, comprises one or more instructions for:
sequentially inputting T traffic data determined based on the T traffic values of each object node at T time points into the temporal sequence network, wherein t^{th} traffic data among the T traffic data comprises a sequence formed by a first traffic value to a t^{th} traffic value among the T traffic values in time sequence; and
processing, using the fused representation matrix, inputs in the temporal sequence network to obtain the predicted traffic value of each object node at a time point after the T time points.

17. The non-transitory, computer-readable medium of claim 16, wherein processing, using the fused representation matrix, inputs in the temporal sequence network to obtain the predicted traffic value of each object node at a time point after the T time points, comprises one or more instructions for:
performing, at a hidden layer of the temporal sequence network and using the fused representation matrix, linear transformation processing on traffic data inputted at a current time point and a hidden layer state at a previous time point; and
determining, based on a result of the linear transformation processing and the hidden layer state at the previous time point, a current hidden layer state.

18. The non-transitory, computer-readable medium of claim 17, wherein determining, based on a result of the linear transformation processing and the hidden layer state at the previous time point, a current hidden layer state, comprises one or more instructions for:
performing nonlinear activation processing on the result of the linear transformation processing; and
determining, based on a result of the nonlinear activation processing and the hidden layer state at the previous time point, the current hidden layer state.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for updating a traffic prediction system, comprising:
generating, using a graph generation module and based on node representation parameters in the graph generation module that are used to represent N object nodes, first graph structure data, wherein the first graph structure data indicates connectivity relationships mined for the N object nodes;
processing, using a first graph neural network, the first graph structure data and node traffic data to obtain N first embedded representations of the N object nodes, wherein the node traffic data comprises T traffic values of each object node at T time points;
processing, using a second graph neural network, second graph structure data and the node traffic data to obtain N second embedded representations of the N object nodes, wherein the second graph structure data indicates original connectivity relationships pre-generated for the N object nodes;
performing, based on the N first embedded representations and the N second embedded representations, fusion processing to obtain a fused representation matrix;
processing, using a temporal sequence network, the fused representation matrix and the T traffic values of each object node at T time points, and determining a predicted traffic value of each object node at a time point after the T time points; and
updating parameters in the traffic prediction system based on the predicted traffic value of each object node at a time point after the T time points and a corresponding actual traffic value.

20. The computer-implemented system of claim 19, wherein:
business objects corresponding to the N object nodes are application software and traffic is data traffic; or
the business objects are points of interest (POIs), and the traffic is a road traffic.
